(19) United States
(12) Patent Application Publication
(10) Pub. No.: US 2006/0211341 A1
(43) Pub. Date: Sep. 21, 2006

(54) Apparatus and method for edging stone or stone tiles

(76) Inventor: Paul L. Aston, La Mesa, CA (US)

Correspondence Address: WILLIAM J. KOLEGRAFF, 3119 TURNBERRY WAY, JAMUL, CA, 91935, US

(21) Appl. No.: 11/255,166

(22) Filed: Oct. 20, 2005

Related U.S. Application Data
(60) Provisional application No. 60/620,306, filed on Oct. 20, 2004.

(51) Int. Cl. B24B 1/00; B28D 1/18

(52) U.S. Cl. 451/44; 125/3

(57) ABSTRACT

A stone machine and a process for working the edge of a stone or a set of stone tiles is provided. The stone machine has a stone receiving area, where stones are placed and their back edges aligned. A lift bar moves a pressure plate so that the pressure plate applies a variable level of force to the bottom surface of the stone. The pressure plate causes the top surface of the stone to be pressed against an alignment pad, which aligns the top surfaces and secures the stones for working. With the stones secured, a power tool moves to cut, grind, or polish the front edge of the stones.

### RELATED APPLICATIONS

This application claims priority to U.S. provisional patent application No. 60/620,306, filed Oct. 20, 2004, and entitled “Apparatus and Method for Edging Stone or Stone Tiles”, which is incorporated herein in its entirety.

### BACKGROUND OF THE INVENTION

1. Field of the Invention

The present invention relates to the field of mechanical stone machines. More particularly, the present invention relates to a device and method for grinding, cutting, or polishing an edge of a stone tile or a stone slab.

2. Description of the Related Art

Skilled stonemasons have worked and installed stones and stone tiles for thousands of years. Since those early times, the process of working with stone has included first cutting, then shaping, and finally polishing the stone. Of course, modern power equipment has assisted in speeding the processes, but these time-honored skills are still important in the stone arts. Today, stones, stone slabs, and stone tiles are cut from quarry stock and distributed throughout the world. Large stones and slabs may be further worked in a manufacturing location, but smaller stones and stone tiles are often delivered directly to a job site, where they are fit, shaped, and polished. Even the larger stock, which may be shaped and polished in a remote location, often must be worked or modified at the job site. There, the skilled and patient stoneworker applies the age old practice of cutting, grinding, and polishing.

However, cutting, grinding, and polishing stone at a job site has several problems. For example, even a skilled stonemason can only work a limited amount of stone or stone tiles in one day. These skilled artisans are expensive to employ, and may even be hard to find, thereby delaying an entire project. Further, working at a job site requires the use of portable tools, which typically are of a lower quality and precision than those tools available in a fixed manufacturing facility. Accordingly, stone worked at a job site may suffer from imperfections that result in an unappealing and low-quality appearance to the stone work. In one example, a stonemason may need to install a set of granite stone tiles at the edge of a counter. Such tiles may be 12″×12″ or some other common dimension, and come with mostly square edges and a polished top surface. For aesthetic purposes, the stonemason may desire to grind a pleasing bullnose on the stone's front edge, and then polish the new bullnose to match the polish on the top surface of the stone tile. However, stone tiles have several deficiencies that complicate the stonemason's work. First, the stone tiles may not all be the same length, or some stones may have chipped or deformed edges. To use these stones, the lengths should be the same, and there should be no cracks or blemishes that are deeper than the volume to be ground away. Too, all the pieces may need to be cut, as the remaining edge length may be less than a full size piece. For a pleasing finish, each stone needs a squared front edge, and all pieces should be the same length.

Accordingly, the stonemason needs to first cut the stones to a consistent length, and then grind in the bullnose. However, the job is complicated because stones and stone tiles typically vary in thickness. The thickness may vary from one end of a stone tile to the other end, and the thickness may vary from one stone tile to the next stone tile. In a proper installation, irrespective of the thickness of the stone, the top surfaces are aligned and level. This variation in thickness not only is concern for installation, but makes it more difficult for the stonemason to work the stone tiles. For example, the stonemason may attempt to clamp the set of stone tiles against a work bench to use a grinder to cut the tiles to length, and then use a router to grind the bullnose into the front edge. However, the clamps will be too tight where the stone is thick, which may damage the stone, and the clamps may be ineffective where the stone is thinner, allowing the stone to slip. Attempting to cut and grind such inadequately clamped tiles may be dangerous, as well as result in an unappealing aesthetic result.

Because it is so difficult to clamp stones, the stonemason may choose to install the set of tiles at the edge of the counter, allow them to properly set, and then cut and work them while in place. In this regard, the mason may use a handheld grinder or saw to cut the stones to a desired length, and then use a router to grind in the bullnose edge. Unfortunately, even a good stonemason is unlikely to operate the handheld tools with great precision and stability. This leads to inaccurate cuts, gouges, unevenness, and a wavy appearance to the edge. Also, the stonemason tries to stabilize the router by pushing it along the top surface of the tile. In this way, the base of the router frictionally engages the finished top surface, and may mar or scratch the polished surface. This is especially true as the grinding bit is ejecting small pieces of stone, which act as grit between the router place and the stone surface. Using such handheld tools, even in the hands of a skilled craftsman, may result in an inconsistent and unpleasing result.

Whether clamped or installed, after the granite tiles are edged with a bullnose, it is often desirable to polish the new edge to match the polished finish on the stone's top surface. The stonemason, using a sequence of different bits, will polish the edge. These polishing steps are difficult to perform, and often produce undesirable and inconsistent results. To polish granite, up to 8 successive polishing pads are used. The coarsest pad is applied first to the edge, typically with a handheld grinder. Then, up to 7 successively finer pads are used. If an area is missed, or over ground, at any step in the process, the process begins again at the coarsest pad. Since the stonemason is using an unstable handheld tool, it is likely that edges will take considerable time, or the stonemason may have to settle for a less pleasing finish.

Therefore, a need exists for a device and process that can accurately and efficiently work stone and stone tiles.

### SUMMARY OF THE INVENTION

Briefly, the present invention provides a stone machine and a process for working the edge of a stone or a set of stone tiles. The stone machine has a stone receiving area, where stones are placed and their back edges aligned. A lift bar moves a pressure plate that is constructed so that the pressure plate applies a variable level of force to the bottom surface of the stone. The pressure plate causes the top surface of the stone to be pressed against an alignment pad, which aligns the top surfaces and secures the stones for working. With the stones secured, a power tool moves to cut, grind, or polish the front edge of the stones.

In one example of the stone machine, the stone machine uses a set of load-rated bumpers as the pressure plate. The bumpers may interlock to form a contiguous member, or may be arranged independently. Each bumper is constructed to apply a force to an area of a stone directly above it. Since each bumper acts independently, each bumper is able to provide the proper level of force, irrespective of the thickness of the stone at that bumper. In this way, the pressure plate is enabled to accurately align the top surface of the stones, even when the stones have thickness irregularities. In another example, the stone machine uses stabilization pads to assist in lifting the stones toward the alignment pad. These stabilization pads squarely lift the stones into clamping position prior to the pressure plate applying full force, and may drop away after the pressure plate has secured the stones. In another example, the stone machine uses a recirculating water system to cool and clean the power tool's bit.

The stone machine enables an operator to efficiently and consistently cut, grind, or polish a stone or a set of stones. The operator is able to produce more finished stones, and a more consistent quality as compared to hand-working the stones. The stone machine may operate accurately a set of successive steps on one set of stones, for example, by first cutting, then grinding, and then polishing with successively finer grit wheels. Because the stones remain secured during the successive passes of the power tool, and the tool is stable and accurately positioned to the stone, the successive passes may be made efficiently and confidently. Also, the power tool does not slide or rest on the top surface of the stones. In this way, the edges may be worked without marring, scratching, or dulling the top surface of the stones. The stone machine enables a lower-skilled worker to efficiently produce accurate and aesthetically pleasing stones or stone tiles.

These and other features will become apparent by review of the figures and detail descriptions that follow.

### BRIEF DESCRIPTION OF THE DRAWINGS

The present invention is described herein with reference to the following drawings. The drawings are provided for purposes of illustration only and not limitation. It should be noted that for clarity and ease of illustration these drawings are not made to scale.

FIG. 1 is a perspective front illustration of a stone machine in accordance with the present invention;

FIG. 2 is a perspective rear illustration of the stone machine of FIG. 1;

FIGS. 3a-3f is a diagram of a stone machine in accordance with the present invention;

FIG. 4 is a diagram of a stone machine in accordance with the present invention;

FIG. 5 is a flowchart of a process of working a stone in accordance with the present invention;

FIG. 6 is a flowchart of a process of working a stone in accordance with the present invention;

FIG. 7 is a diagram of a stone machine in accordance with the present invention;

FIG. 8 is a diagram of a stone machine in accordance with the present invention;

FIG. 9 is a perspective illustration of a stone machine in accordance with the present invention; and

FIG. 10 is a diagram of a stone machine in accordance with the present invention.

### DETAILED DESCRIPTION OF THE PREFERRED EMBODIMENT

Certain embodiments of the invention are described below in connection with the drawings. It should be understood that the invention is not limited by the detailed description and the drawings, but is to be defined by the scope of the appended claims.

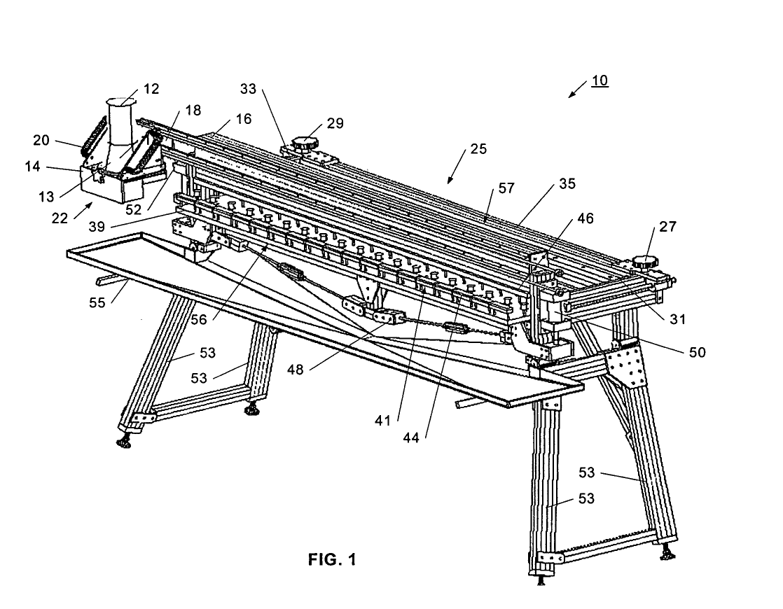

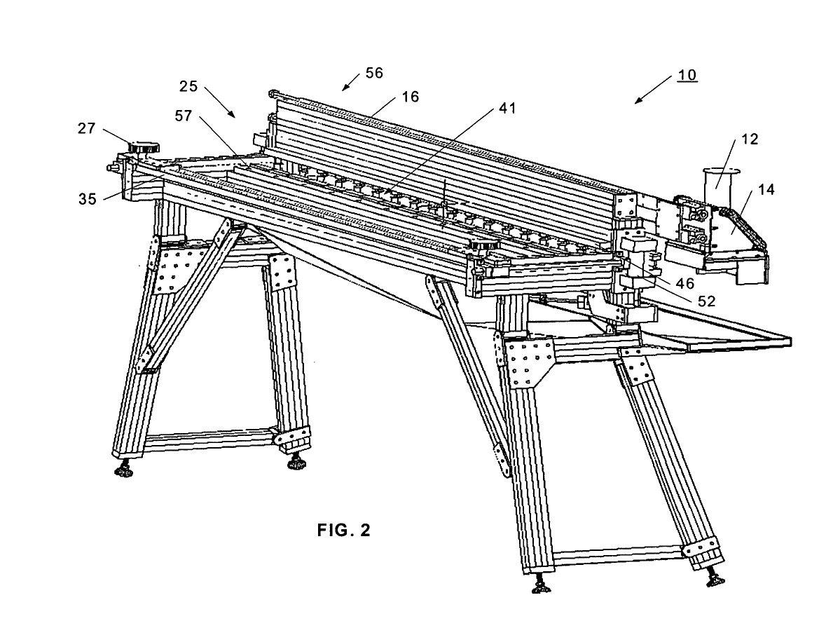

Referring now to FIGS. 1 and 2, a stone machine 10 is illustrated. Stone machine 10 may advantageously operate on a stone or a set of stone tiles. The stone or stone tiles may be for example, granite, marble, travertine, limestone, or other commercial or residential stone material. It will also be understood that stone machine 10 will advantageously work the edge of a stone block or stone slab. Stone machine 10 is generally illustrated to be about 6 feet in length, thereby able to hold up to about five or six 12″×12″ stone tiles. It will be appreciated that smaller or larger tiles may be used. It will also be appreciated that stone machine 10 may be constructed on a larger or smaller scale. For example, a smaller version of stone machine 10 may be made, for example, about 3 feet wide, to allow greater portability. In this way, the stone machine may be transported to a job site, and a stone worker work the edges of stones close to where the installation is being performed. In another example, stone machine 10 is made longer and deeper to accommodate larger stone tiles, more stone tiles, or larger stone slabs. Such a stone machine would typically be installed in a more permanent location, and the stone worked and then transported to a job site.

Stone machine 10 has a main support beam 16 generally extending from one end of the stone machine to the other. Beam 16 may be constructed, for example, from stainless steel. Stainless steel is a strong material and also provides desirable corrosion resistance. It will be appreciated however, that other materials, such as extruded aluminum, may be used for the construction for the beam 16 and other members of the stone machine. A set of rails 18 is attached to the beam 16. The elongated rails 18 are securely attached to the elongated beam 16, so that a router support 14 may freely traverse the length of the beam 16. The router support 14 holds a router power tool 12. The router 12 has a router body 13 which drives a shaft and bit holder 22. The bit holder 22 is constructed to receive a bit to work the edge of the stone tiles. For example, the bit holder 22 may receive a bit for putting a bullnose edge on a stone, or receive bits for polishing and finishing the edge. It will be appreciated that a wide variety of grinding, finishing, and polishing bits may be used in router 12. Router support 14 may also have a pivot 20. The pivot 20 enables the router holder 14 to pivot for applying different edges to the stone edge. Additionally, the pivot may allow the router support 14 to rotate so that a cutter bit may be inserted into the bit holder 22. When configured with the cutting bit, the stone machine 10 is able to cut a straight edge onto the front edge of the stone tiles. Once the edges have been cut, then the router 12 may be rotated and a grinding or polishing bit attached. In this way, stone machine 10 can be used for cutting, grinding, and polishing the front edges of a set of stone tiles.

The stone machine desirably has the router mounted into a router support. Since the router is supported from the beam, the router body does not rest on or frictionally traverse the top surface of the stone. In contrast to known methods the router is able to smoothly and accurately traverse the front edge of the stone without scratching, marring, or dulling the top surface of the stone. The router may be a commercially available router, or a stone grinding motor and assembly may be constructed. A typical commercial router rotates at between 6000 and 10000 rpm, which is useful for most cutting and grinding purposes. However, a slower speed router or motor may have to be used for polishing. For example, some polishing bits may operate most effectively at speed of between 2000 and 4000 rpm. It will be appreciated that the router or grinder motor is selected according to expected usage and stone characteristics.

Stone machine 10 also has a tile area 25 for receiving a stone slab or a set of stone tiles. The stone slab or stone tiles are inserted so that the back edge of the tiles or slab align with the backstop bar 35. The backstop bar 35 is locked into position with scale locks 27 and 29. Calibrated scales 31 and 33 may be positioned adjacent the scale locks 27 and 29 to assist an operator in setting a desired tile length. The backstop bar 35 is parallel to the path that the router 12 takes while traversing the rail 18. By adjusting the backstop bar 35, the length of the tile pieces are adjusted. For example, if ten-inch finished tiles are desired, and the stone tiles are received as 12×12 inch raw stock, then the operator adjusts the backstop bar 35 so that the scale is set to ten inches. The operator then locks the scale lock 27 and 29, and places the tiles in tile area 25. The tiles are arranged so that the back edge of the tiles are aligned with the backstop bar 35. Since the dimensions of the raw tile stock may be irregular, the front edge of the tiles may be quite uneven. When inserted into the tile area 25, each tile extends from the backstop bar 35 through an opening defined between the alignment pad 46 and the bumpers 41. The size of the tiles and the setting of the backstop bar 35 must be such that the tiles extend far enough through the opening to engage a bit inserted in router holder 22.

The alignment pad 46 is an elongated flat piece of dense plastic firmly attached to the beam 16. The alignment pad material is selected to minimize scratching or impacting the top surface of the tile. It will be appreciated that other materials may be used for the alignment pad. It will also be appreciated that the alignment pad may be alternatively positioned. A pressure bar in the form of a set of bumpers 41 is positioned below the bottom surface of the set of tiles. Each bumper, such as bumper 44, is constructed to apply a level of pressure to an area on a stone directly above that bumper. A piston 50 operates to move a lift bar 39. The lift bar 39 is a strong elongated member for simultaneously moving the set of bumpers 41 toward the alignment pad 46. The set of bumpers 41 are arranged as the pressure plate. This pressure plate is able to apply a varying level of pressure across the stone tiles, while securing the tiles against the alignment pad 46. It will be appreciated that the pressure plate may be constructed in alternative ways. In this way, as the piston 50 is activated, the stone tiles are compressed between the set of bumpers 41 and the alignment pad 46. Because of irregularities in thickness of individual tiles and irregularities between tiles, the bumpers may each apply a different pressure against its stone tile. Each of the bumpers such as the bumper 44, is a load rated bumper. These load rated bumpers may be spring loaded, and have a firm rubber pad for engaging the bottom surface of the tiles.

As each bumper is raised by the lift bar 39, it firmly engages an area of the tile directly above it, and firmly pushes the stone tile against the alignment pad 46. It has been found that a 12 inch stone may be firmly secured into place with approximately 120 pounds of pressure. If the bumpers are spaced-apart two inches, then six bumpers are used to engage each 12 inch tile. With six bumpers, each bumper would apply approximately 20 pounds of force to an area of a tile. Of course, it will be appreciated that the specific force each bumper applies is dependant on the thickness of the tile at the point where the bumper presses against the tile. For example, if an area of a tile is particularly thick, then the bumper associated with that area will apply a greater pressure than a bumper applied to a thinner area of tile. Because each bumper independently applies pressure to a relatively small area of a stone tile, the bumpers 41 act to securely hold a set of tiles irrespective to the irregularity in thickness of the tiles. It is particularly important that the top surfaces of the stone tiles are accurately aligned. When secured in place, the top surface of the tiles and the back edges of the tiles are accurately aligned.

To assure the set of tiles is accurately and securely raised and pressed against the alignment pad 46, and additional piston 52 may be used piston 50 and piston 52 may be, for example, pneumatic driven. To assure similar response from piston 50 and piston 52, the hose from the air regulator system to each of the pistons is kept the same length. Further, each piston applies its force to the lift bar 46 through a linear bearing. In this way, the substantial and prolonged force of the pistons is properly managed and binding is greatly reduce. To further assist in consistently and accurately raising the set of tiles, the stone machine 10 may use one or more sets of stabilization pads. For example, stone machine 10 has a back set of stabilization pads 57 which act to raise the set of tiles toward the alignment pad 46 prior to the bumpers 41 contacting and pressuring the set of tiles. The back stabilization pads 57 are actuated by the pistons through a linkage 48. The stabilization pads move on pivots in a manner that allows the stabilization pads 57 to first raise the set of tiles toward the alignment pad, and as the pressure plate contacts the tiles, the back stabilization pads 57 rotate away from the set of tiles. Stone machine 10 also has a front set of stabilization pads 56. In a similar manner, front stabilization pads 56 engage through linkage 48 to push the set of tiles toward the alignment pad prior to the bumpers 41 pressuring the set of tiles. In this way, the back stabilization pads 57 and the front stabilization pads 56, cooperate to accurately and consistently lift the tiles generally into alignment position prior to the bumpers 41 engaging and applying full pressure. In one example, the stabilization pads are a row of individual padded supports, each space about 2 inches apart. It will be understood that the size, shape, and spacing of the stabilization pads may be adjusted according to application specific needs Each support may be spring loaded, or may have a spongy or flexible surface. In this way, the stabilization pads cooperate to squarely raise a set of stone tiles, even when the tiles have an irregular thickness. In another example, the stabilization pads may be constructed as a bar, with the bar moving or pivoting to raise the set of tiles. The bar may have a padded or rubber surface to accommodate thickness irregularities in the tiles. It will be appreciated that more or fewer sets of stabilization pads may be used. For example, a third set of stabilization pads may be used for larger tiles or larger slabs of stone. In another example, a 24 inch file may require 3 sets of stabilization pads: one near the front edge, one near the pressure plate, and one near the back edge of the files. In this way, even large tiles may be raised generally perpendicular to the alignment pad, thereby reducing tile movement and misalignments as the pressure plate engages the bottom surface of the tiles.

Stone machine 10 may also be constructed with a recirculating water system. When cutting, grinding, or polishing stone edges, water is commonly sprayed at the interface between the router bit and the edge of the stone. The water not only cleans this interface, but keeps the bit cooler, thereby increasing bit life and promoting a quality edge finish. To accommodate a water spray system, stone machine 10 may include a water jet adjacent to a bit, which sprays water towards the bit and stone edge. The water is collected in water tray 55, and the water directed towards a collection vessel. The collection vessel allows large particulate to settle, and additional filtering may be performed on the water. A pump is then used to recirculate the water back through the spray jet at the router bit. In this way, the stone machine 10 becomes a self contained edging device, without need for continuous hook-up to water and sewer facilities. Of course, the particulate vessel may need to be periodically emptied, and additional water may need to be added due to evaporation and splashing effects.

Stone machine 10 is illustrated on legs 53. The legs 53, as well as other supporting members of the stone machine 10, may be constructed from stainless steel. Stainless steel is desirably used due to its structural characteristics and its corrosion resistance. It will be appreciated that other materials may be used. For example, an extruded aluminum product may be used for the legs 53, as well as other structural supporting members. It will also be appreciated that stone machine 10 may be mounted directly on a work platform or on a portable platform such as a truckbed or trailer.

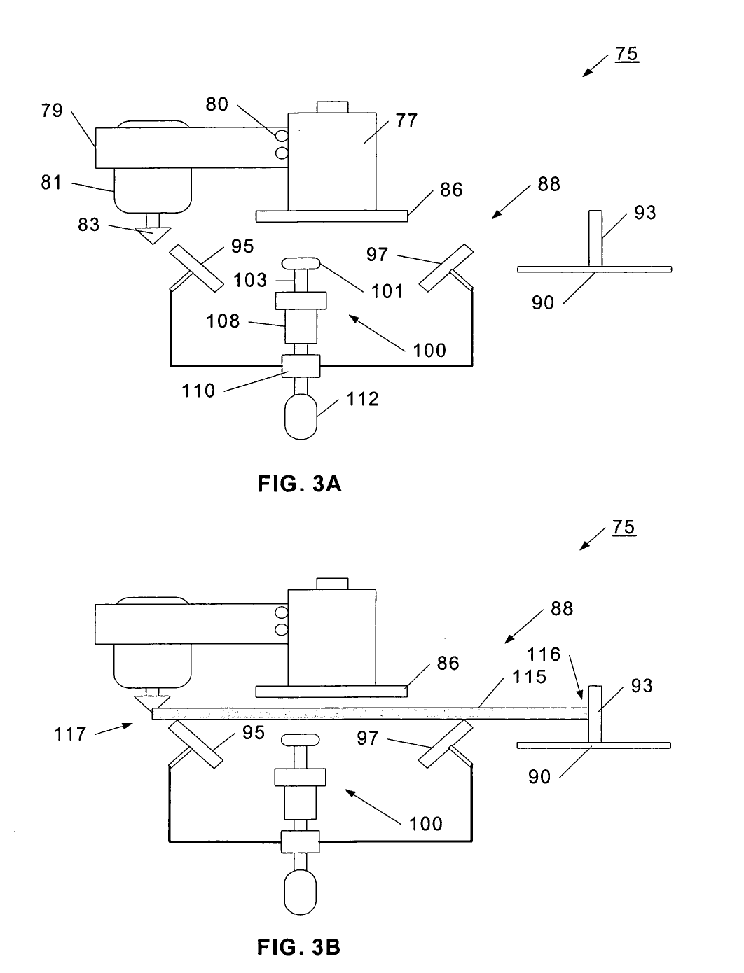

Referring now to FIG. 3A, another stone machine 75 is illustrated. To facilitate understanding of stone machine 75, stone machine 75 is illustrated with several members and interconnecting parts not illustrated. It will be appreciated that general construction techniques and mechanical connection detail is well understood and will not be described in detail herein. Stone machine 75 has an elongated beam 77. The elongated beam 77 has a set of rails 80 enabling a router support 79 to traverse the length of beam 77. A router 81 is attached to the router support 79. In one example, the router 81 may pivot to enable edging work or cutting work. A bit 83 is attached to the router 81 for engaging the stone or stone tiles. The elongated beam 77 has an alignment pad 86 attached to its bottom surface. The alignment pad 86 is an elongated flat and generally rectangular piece for engaging the top surface of the stone or stone tiles. The alignment pad 86 is made of a material intended to minimize scratching and denting of the stone surface. The stone machine 75 also has a tile area 88 for receiving stone tiles or stone block. When positioned in the tile area 88, the stone or stone tiles have their back edge aligned against a backstop bar 93. A scale 90 may be used to assist in setting the proper length for the set of tiles or stone.

The stone machine 75 also has a piston 112 which connects through linkage 110 to a set of front stabilization pads such as stabilization pad 95 and a set of back stabilization pads such as stabilization pad 97. These stabilization pads, as will be explained below, assist in consistently and accurately raising the stone or stone tiles prior to full engagement of the pressure plate. The construction of pneumatic linkage 110 is well known and will not be discussed in detail herein. The piston 112 also acts to move a compression arm 108. The compression arm 108 applies pressure to a set of bumpers 100. Together, the set of bumpers cooperate to provide a pressure plate. In one example, the pressure plate has bumpers spaced apart approximately every 2 inches. In this way, each bumper applies a pressure to a relatively small area on an individual tile. Since each bumper 100 is able to individually apply pressure, the bumpers 100 may accommodate irregularities in thickness of the tiles. Each of the bumpers 100 may be a load rated bumper, having a spring 103 and a pad 101 rated for handling a particular level of pressure. In a specific example, if each bumper is spaced apart 2 inches from the next bumper, then a 12 inch wide tile will be supported with 6 bumpers. It has been determined that 120 lbs. of force securely holds a 12 inch tile in place. Accordingly, each bumper therefore applies about 20 lbs. of force to the tile. It will be appreciated that some bumpers will apply more force, and some bumpers will apply less force, dependent on several factors, such as the thickness of the tile. It will be appreciated that other levels of force may be used to secure different materials. For example, some thicker materials may require additional compression forces, as well as larger slabs of stone may require more holding power. In a similar manner smaller tiles and more fragile material may use less pressure. To accommodate such varying levels of overall pressure, the stone machine 75 may have a pressure regulator and pressure valve for adjusting overall pressure.

FIG. 3A shows stone machine 75 ready to receive a set of stone stiles. FIG. 3B shows a stone tile 115 inserted into tile area 88. Each of the stone tiles, such as stone tile 115, is aligned so its back edge 116 is pressed against the backstop bar 93. The front edge 117 of tile 115 extends between the alignment pad 86 and the set of bumpers 100. In this way, the front edge 117 extends into an area where it may engage the router bit. When inserted, the tile 115 rests on the front stabilization pad 95 and the back stabilization pad 97. It will be appreciated, however, that an additional resting frame may be provided for stone machine 75. In this way, the stone tiles may be inserted and rest on the resting frame and then the stabilization pads engage the stones as the piston is activated.

Referring now to FIG. 3C, the stone machine 75 is shown with piston 112 beginning its activation cycle. When activated, piston 112 rotates front stabilization pad 95 and back stabilization pad 97 to consistently and accurately raise tile 115 towards the alignment pad 86. The movement of the stabilization pads is enabled through linkage 110, and may be a linear movement or a more rotational movement. The piston, either through linkage 110 or through a more direct path, may also begin moving the bumpers 100 towards the tile 115. However, the tile 115 is substantially raised toward the alignment pad 86 prior to the bumper 100 engaging a tile 115 with substantial force. As tile 115 contacts the alignment pad 86, the bumper 100 contacts the tile 115 as shown in FIG. 3D. As the bumper 100 continues to raise and press against tile 115, the spring 103 compresses. The spring continues to compress as shown in FIG. 3E, and the bumper is pressed towards the alignment pad 86 until full compressive force is reached. As the force of the bumper increases, the stabilization pads 95 and 97 rotate or move away from the tile 115 to assure the stabilization pads do not interfere with the cutting process, as shown in FIG. 3F. Alternatively, the stabilization pads may continue to engage the tile to assist in stabilizing the tile. It will also be appreciated that more or fewer sets of stabilization pads may be used, as well as additional sets of bumpers.

When the tile is fully secured and aligned in the stone machine 75, the router traverses the rail 80, while the router 81 bit 83 works the front edge of the stone 115. The router 81 may be moved manually on the rails, or alternatively may have an automatic or motorized drive. A cable carrier 82 may be associated with the rail 88 to safely and conveniently route water and electricity lines to the router 81. It will also be appreciated that the router may make multiple passes on the front edge to more cleanly finish the stone tiles. Further, it will be appreciated that the bit may be changed while the stone tiles are pressed into alignment. For example, a bullnose bit may be first applied to the stone tiles, and then a polishing bit may be inserted and one or more polishing steps completed. It will be understood that the router may need some adjustment to accommodate sizes and diameters of particular bits.

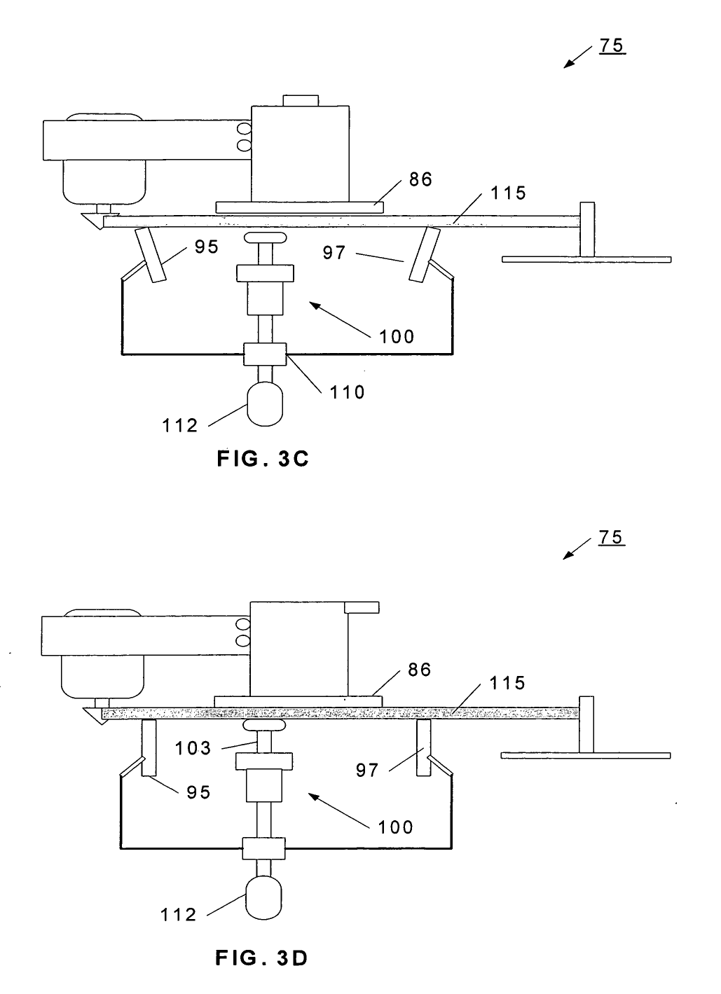

Referring now to FIG. 4, a stone machine 125 is illustrated. Stone machine 125 has an elongated beam 127 on which rails 129 and 130 are mounted. A router 131 is mounted either directly on the rails or through a router support. The router 131 has a router bit 132 for placing an appropriate edge, polishing, or cutting stone tile. An alignment pad 148 is attached to the bottom surface of beam 127. A piston 133 either directly or through linkage 135 applies a force to compression arm 137. In one example, the force is applied through linear bearing 142 and linear bearing 144. It will also be appreciated that more than one piston may be used, and more linear bearings may be used. This could be useful, for example, in working larger slabs of stone or with stone machines that are set to handle more tiles simultaneously. The compression arm 137 is used to compress a set of bumpers 146 against the bottom surface of a set of tiles. Stone machine 125 is illustrated with tiles 161, 162, 163 and 164 in tile area 150. The stone machine 125 is shown in its fully compressed position, with the top surface of the tiles aligned against the alignment pad 148, and the back edge of the tiles aligned against a backstop bar. In this way, any irregularity in thickness is accommodated using the bumpers 146, and any irregularity in tile length is seen at the front edge of the tiles. Once positioned, the router 131 traverses the rails 129 and 130, and the bit 132 puts a consistent and finished edge on the stone tiles. Stone machine 125 is illustrated with four 12×12 tiles inserted. The bumpers 146 are shown spaced apart approximately 2 inches. In this way, each tile is supported by 6 bumpers. Also, the bumpers are positioned at odd increments. For example, tile 161 is supported at 1 inch, 3 inches, 5 inches, 7 inches, 9 inches, and 11 inches. In this way, the bumpers do not press against an edge of the tile, which could break or cause misalignments. Since most common tiles are made in even dimensions, such as 8, 12, 16, or 18 inches, a 2 inch spacing on odd increments accommodates most standard stone tile sizes.

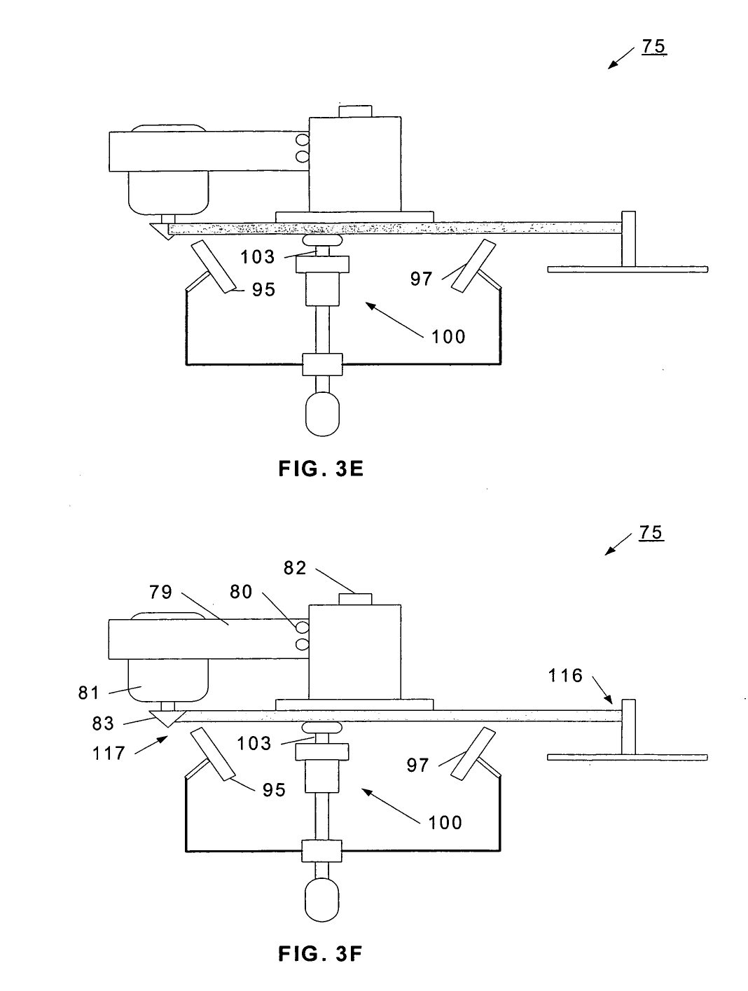

Referring now to FIG. 5, a method for edging a stone is illustrated. Method 200 starts with an operator aligning the back edge of a stone against an alignment member as shown in block 201. In one example, the alignment member is a backstop bar of an edge grinding machine. Once the back edges are aligned, the stones are pressed to align the top surfaces of the stones as shown in block 204. For example, a strong and flat member may be placed on top of the stone tiles, and a force applied to the bottom surface of the tiles. If the pressure is applied by a pressure plate having the ability to apply a variable pressure, then the stones may have their top surfaces accurately aligned. Such a variable pressure may be generated by using a series of spring loaded bumpers, with each bumper independently applying a force to a small area of a stone tile. In another example, the pressure plate may be formed using a firm but pliable rubber material. In this way, the rubber material presses against the bottom surface of the stone tiles, with more force applied to thicker areas of the stones, and less force applied at thinner areas of the stones. It will be appreciated that other constructions and arrangements may be used to apply a variable force to the bottom surface to a set of stone tiles. Once sufficient force has been applied to the bottom surface of the tiles, the stones are secured into position as shown in block 207. With the stones secured, a power tool, such as a router power tool may be used to work the front edge of the stone as shown in block 210. For example, the stone may be cut, the stone may have a bullnose or other edge ground, or the front edge may be polished.

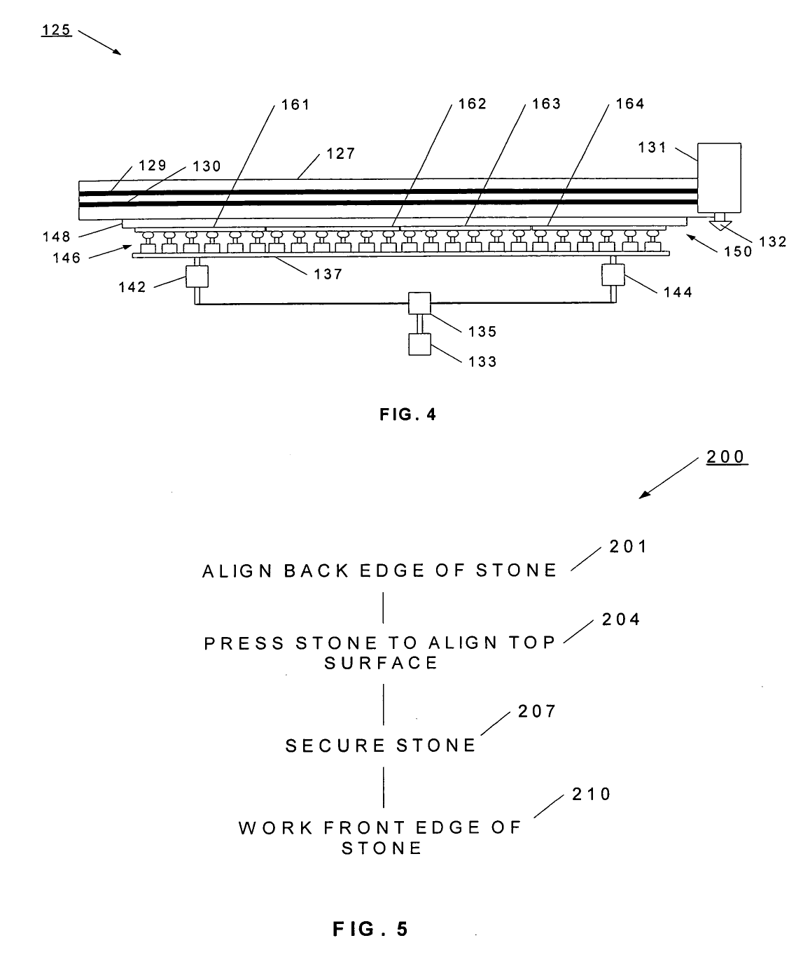

Referring now to FIG. 6, a method 250 is shown for edging the stone. In method 250, a backstop bar is set to a desired length as shown in block 252. Once the length has been set, the back edge of the stones are aligned to the backstop bar as shown in block 254. One or more sets of stabilization pads or guide bars are used to move the stones upward toward an alignment pad as shown in block 256. It will be appreciated that the number of sets of stabilization pads may depend on application specific needs, such as stone weight, number of tiles used, thickness of tiles, and other factors. In a specific example, a front set of stabilization pads and a back set of stabilization pads are used to generally raise the tile in a perpendicular manner toward the alignment pad. Once the stabilization pads have moved the stone sufficiently toward the alignment pad, a set of load rated bumpers are applied to the bottom surface of the stone tiles as shown in block 258. Since each individual bumper is able to independently apply pressure, the bumpers automatically account and accommodate for differences in thicknesses in an individual stone and differences in thicknesses between stone tiles. As the pressure is increased on the bumpers, the stone tiles are pressed against the alignment pad which aligns the top surfaces of the stone tiles as shown in block 261. In some cases, as the stone tiles are secured against the alignment pad, the stabilization pads may drop away from the stone as shown in 263. The router bit is positioned for the desired cut or work as shown in block 266, and the bit is moved across the front end of the stone, to cut, grind, or polish the stone as shown in block 268. It will be appreciated that the bit may be changed, repositioned, and run across the edge again to provide a multi-step sequential process. For example, a set of granite stone tiles may first require a cut to a desired length, and then a bullnose edge applied, and then a set of polishing bits used. For granite, the polishing steps may include up to 7 or more sequential polishing steps. Because the tiles remain secured while bits are changed, the polishing steps may be accomplished accurately and consistently. Once the edges have been properly put on the stone tiles, the stone is released as shown in block 270.

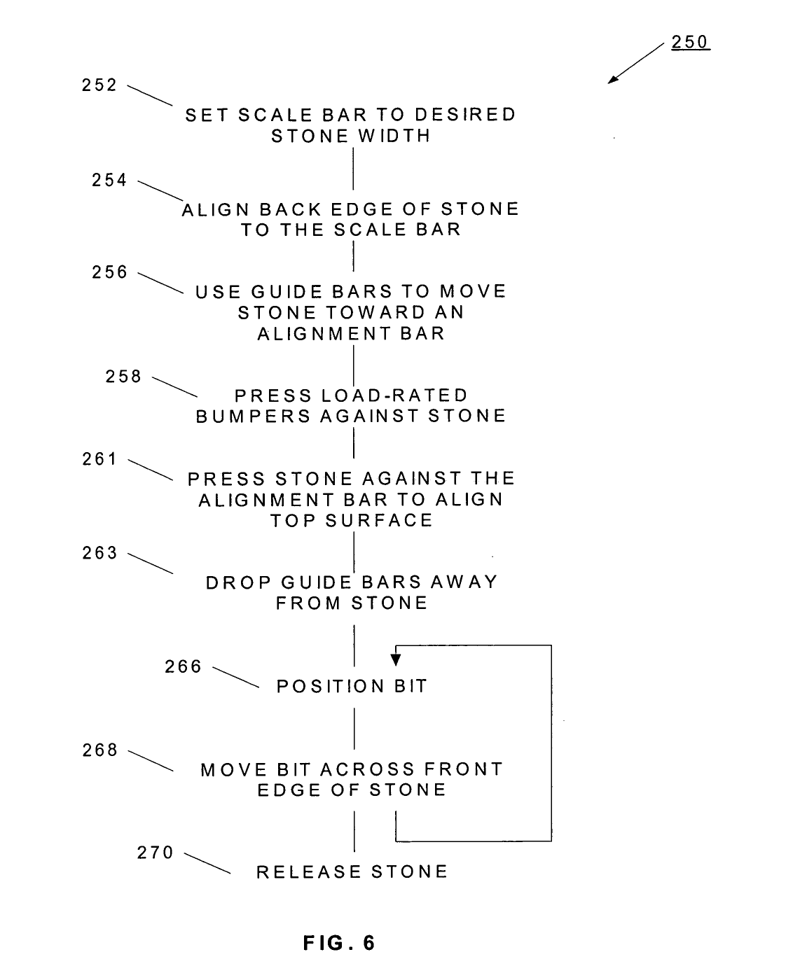

Referring now to FIG. 7, another stone machine 300 is shown. Stone machine 300 has a beam 302 supporting a router support 304. A router 303 drives a bit 306. An alignment pad 336 is attached to the bottom side of beam 302. Stone machine 300 has a piston 325 which acts through linkage 320 to control a set of stabilization pads 328. As previously described the stabilization pads 328 are useful to assist in moving the stone tile into position prior to the bumpers engaging with full pressure. The stone machine 300 also has a scale 330 and a backstop bar 333 for aligning the back edges of the stone tiles. Stone machine 300 has a set of bumpers 310 for securing a tile against the alignment pad 336. When engaged, pad 311 presses firmly against a stone tile while spring 312 compresses depending on the thickness of the tile. The lift bar 314 moves in response to piston 325, either through the linkage 320 or through another mechanism. Stone machine 300 also has another set of bumpers 315 for providing additional support near the front edge of the stone tile. The bumper 315 may move responsive to lift bar 314 or as shown, have its own lift bar 318. Lift bar 318 may move at a different time and rate than lift bar 314 to accommodate a different desired pressure against the front edge of the stone. For example, a somewhat fragile stone material may accommodate a fairly large pressure with bumpers 310 but allow only moderate pressures through bumper 315. Bumper 315 apply its pressure to the front area of the tile through pad 316, for example. Spring 317 would compress according to the pressure applied and the thickness of the stone. Since bumper 315 assists in raising the front end of the tile, stone machine 300 does not need a front set of stabilization pads. However, it will be appreciated that a front set of stabilization pads, a guide bar, or additional bumpers may be used to accommodate applications specific needs.

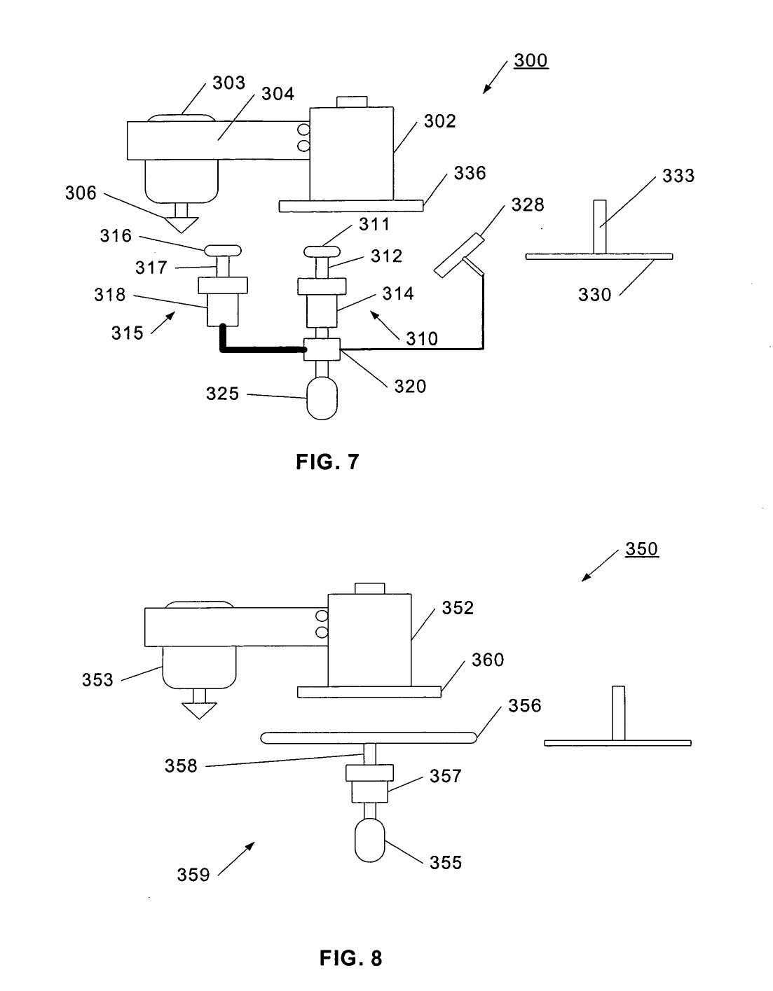

Referring now to FIG. 8 another stone machine 350 is illustrated. Stone machine 350 has a beam 352 supporting an alignment pad 360. A router 353 is configured to engage the front edge of a stone when it is inserted into stone machine 350. Stone machine also has a piston 355 which moves lift bar 357. Lift bar 357 applies a force to set if bumpers 359. Bumpers 359 have, for example, an elongated pad 356 attached to the top of its spring 358. The elongated pad 356 is able to sufficiently support tiles while the tiles are being raised, so stabilization pads need not be used. More specifically, the pad 356 is sized to accurately and consistently raise the stone tile towards the alignment pad 360.

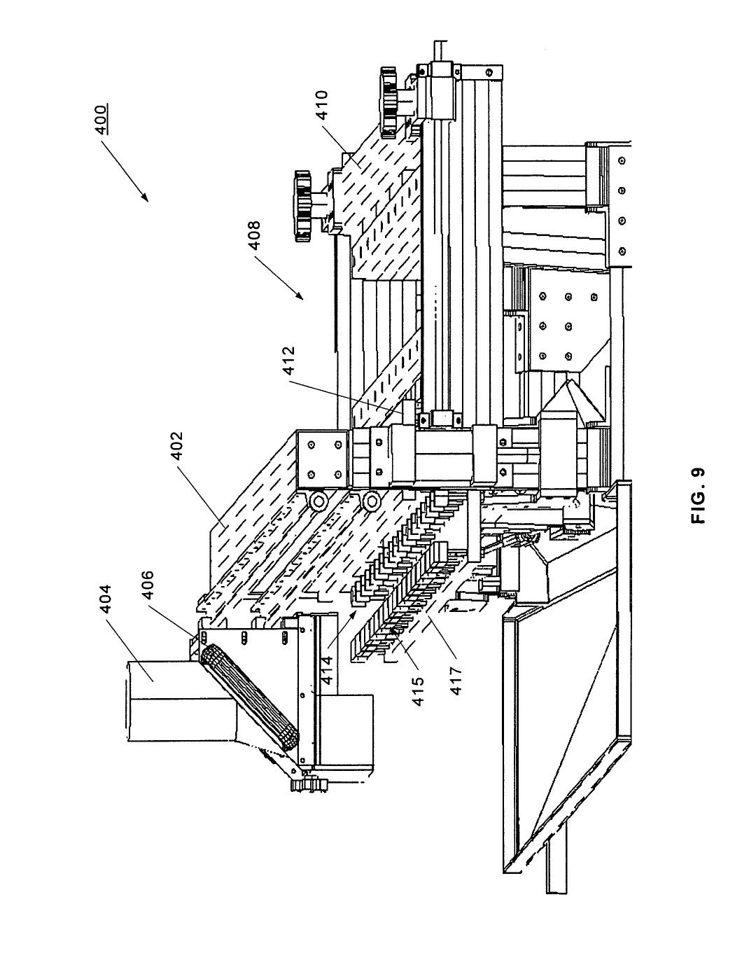

Referring now to FIG. 9, a stone machine 400 is illustrated. Stone machine 400 has a beam 402 extending substantially through the length of the stone machine. The beam 402 has rails on which a router support 406 travels. Router support 406 supports router 404, in a manner that a bit attached to the router is able to work the front edge of the stone. Importantly the router 404 is able to work the front edge of the stone without frictionally engaging the top surface of the stone. In this way the router does not scratch, mar, or otherwise degrade the appearance of the top of the stone. Even though the router 404 does not touch the top surface of the stone (except for the contact by the bit), the router 404 is stability and accurately positioned relative to the front edge of the stone tiles. Stone machine 400 also has a tile area 408 which has an adjacent backstop bar 410. The backstop bar 410 is useful for assisting and aligning the back edge of a set of tiles. It will be appreciated that other structures may align the back edges of the tiles. Also, it will be appreciated that the backstop bar 410 may be used temporarily, and then moved out of the way to accommodate additional work on the back edge. For example, the beam 402 may be constructed to support a router for forming an edge on the back edge of the tile also. An alignment pad 412 is securely attached to the bottom of beam 402. Stone machine 400 has a first set of bumpers 414 for firmly pressing stone tiles against the alignment pad 412, and a second set of bumpers 415 for applying pressure nearer the front edge of the stone tiles. In this way, the front edge of the stone tiles may be more firmly secured. Such additional support may be useful when faster router speeds are used, more aggressive grinding is desired, or thicker or heavier material is used. In stone machine 400, a common compression arm 417 is used to engage both bumpers 415 and bumpers 414. It will be appreciated that the load rating for the bumpers 414 may be set differently than the load ratings for bumpers 415. In this regard, bumpers 415 may have their position and spring strength set to apply less force than bumpers 414.

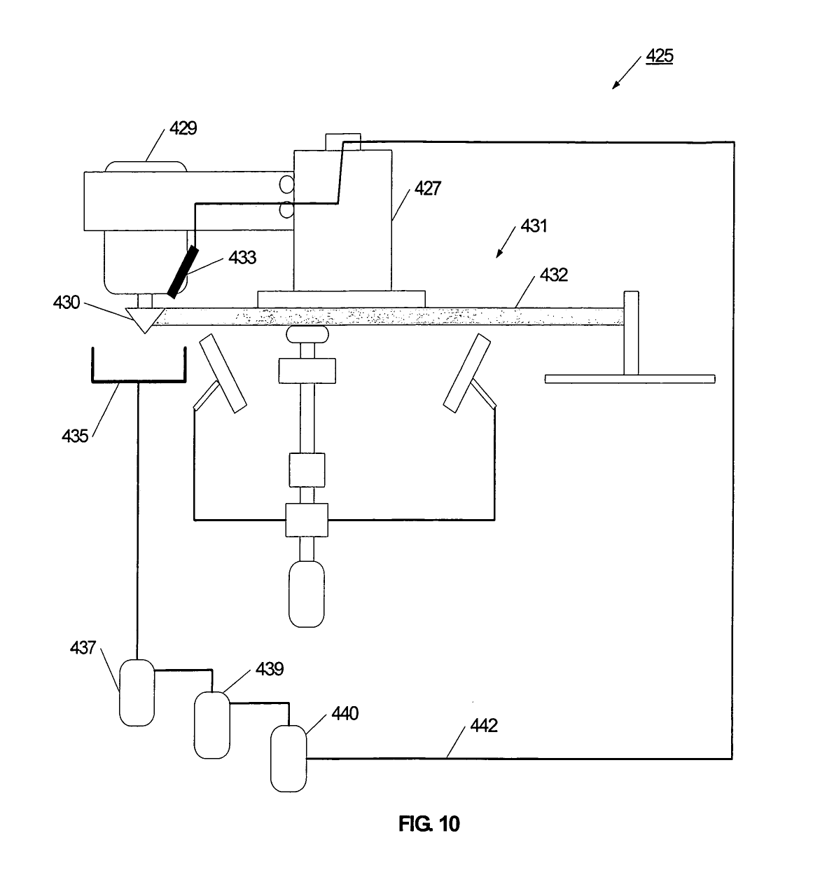

Referring now to FIG. 10, another stone machine 425 is illustrated. Stone machine 425 has beam 427 for supporting router 429. Router 429 drives bit 430 against the front edge of tile 432, which is positioned in tile area 431. A water jet 433 is used to spray water at the interface between the bit 430 and the front edge of the tile 432. The water is useful for cleaning and cooling purposes. The sprayed water is collected into a water tray 435, and directed into a coarse collection vessel 437 where sediment and particulate matter is collected. The water flows from the vessel 437 and may be passed to a fine filter vessel 439. It will be appreciated that other fine filtering methods may be used. Pump 440 is used to pump water from the fine vessel 439 through the recirculation line 442 back to water jet 433 in this way, stone machine 425 may operate without continuous connection to water and sewer. Of course, it will be appreciated that additional water may need to be added due to evaporative and splashing effects, and that the filter and collection vessels may need periodic cleaning.

Although the foregoing has described certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present invention is not to be limited by the preferred embodiments, but is to be defined by reference to the following claims.

What is claimed is:

1. A stone machine, comprising:
a stone receiving area;
a backstop bar adjacent to the stone receiving area and arranged to align a back edge of the stone;
a pressure plate;
an alignment pad;
a lift bar arranged to move the pressure plate toward the alignment pad;
a power tool constructed to work a front edge of the stone;
wherein the stone receiving area comprises an area between the pressure plate and the alignment pad.

2. The stone machine according to claim 1, where the pressure plate comprises a plurality of spaced-apart bumpers.

3. The stone machine according to claim 2, where the spaced-apart bumpers are load-rated and spring-actuated.

4. The stone machine according to claim 1, where the lift bar is coupled to the pressure plate, and movement of the lift bar causes the pressure plate to move.

5. The stone machine according to claim 1, where the lift bar is coupled to the alignment pad, and movement of the lift bar causes the alignment pad to move.

6. The stone machine according to claim 1, where the stone receiving area is arranged to receive the stone as a plurality of stone tiles, and the backstop bar is arranged to align the back edge of each of the stone tiles.

7. The stone machine according to claim 1, further comprising a set of stabilization pads, the stabilization pads constructed to move the stone toward the alignment pad prior to the pressure plate engaging the stone.

8. The stone machine according to claim 7, wherein the set of stabilization pads are constructed as a plurality of independent and spaced-apart support pads.

9. The stone machine according to claim 7, wherein the set of stabilization pads are constructed as a guide bar.

10. A stone machine, comprising:
a stone receiving area constructed to receive a plurality of stone tiles, each tile having a top surface, a bottom surface, a front edge, and a back edge.
an elongated beam having an elongated rail;
a power routing tool mounted to traverse the rail and constructed to work the front edge of the stone tiles;
a first pressure member positioned above the top surface of the stone tiles, the first pressure member engaging the stone tiles between the front edge and the back edge of the stone tiles;
a second pressure member positioned below the bottom surface of the stone tiles, the second pressure member engaging the stone tiles between the front edge and the back edge of the stone tiles;
a backstop bar adjacent the stone receiving area and arranged to align the back edge of the stone tiles;
a lift bar for creating a compressive force between the first pressure member and the second pressure member;
wherein at least one of the first or second pressure members is constructed to apply a varying level of pressure across its length.

11. The stone machine according to claim 10, where the first pressure member is attached to the beam.

12. The stone machine according to claim 10, where the first pressure member comprises a plurality of bumpers.

11. The stone machine according to claim 10, where the first pressure member comprises a plurality of spring devices, each spring device constructed to independently apply a pressure to an area of one of the stone tiles.

12. The stone machine according to claim 10, where the first pressure member is generally flat through its length.

13. The stone machine according to claim 10, where the second pressure member comprises a plurality of bumpers.

14. The stone machine according to claim 10, where the second pressure member comprises a plurality of spring devices, each spring device constructed to independently apply a pressure to an area of one of the stone tiles.

15. The stone machine according to claim 10, further comprising:
a fluid jet arranged to spray fluid on the bit of the power routing tool while the power routing tool is working the front edge of the stone tiles;
a fluid tray for collecting the spayed liquid;
a filter device to remove large particulate matter from the collected fluid; and
a pump receiving the fluid from the filter device and pumping the fluid to the fluid jet.

16. The stone machine according to claim 10, further comprising a set of stabilization pads, the stabilization pads constructed to move the stone tiles toward one of the pressure members prior to the other pressure member engaging the stone.

17. The stone machine according to claim 16, wherein the set of stabilization pads are constructed as a plurality of independent and spaced-apart support pads.

18. The stone machine according to claim 16, wherein the set of stabilization pads are constructed as a guide bar.

19. The stone machine according to claim 10, further comprising a router support for holding the routing power tool, the router support constructed so the router does not frictionally engage the top surface of the stone tile.

20. A method of edging a stone, comprising:
aligning the back edges of a plurality of stone tiles;
simultaneously pressing the bottom surfaces of the stone tiles so that the top surfaces of the stone tiles are aligned against an alignment pad;
supporting a routing power tool on a router support, the router support enabling the router tool to work the front edges of the stone tiles without frictionally engaging the top surfaces of the stone tiles; and
working the front edges of the stone tiles with a bit attached to the power routing tool.

21. The method according to claim 20, wherein the pressing step comprises using a plurality of spring devices, each spring device positioned to apply a pressure to an area on one of the stone tiles.

22. The method according to claim 20, further comprising the steps of:
continuing to press the bottom surfaces of the stone tiles;
changing the bit to a second bit; and
working the front edge with the second bit.
